(19) United States
(12) Patent Application Publication
(10) Pub. No.: US 2008/0300328 A1
(43) Pub. Date: Dec. 4, 2008

(54) Process for the Preparation of Expandable Polystyrene Beads

(75) Inventors: Jurgen Schellenberg, Halle (DE); Gotthard Simmich, Bad Lauchstadt (DE); Rolf-Dieter Klodt, Halle (DE)

Correspondence Address: WHYTE HIRSCHBOECK DUDEK S.C./DOW;Intellectual Property Department, 555 East Wells Street, Suite 1900, Milwaukee, WI, 53202, US

(73) Assignee: DOW GLOBAL TECHNOLOGIES INC., Midland, MI (US)

(21) Appl. No.: 12/050,561

(22) Filed: Mar. 18, 2008

Related U.S. Application Data
(60) Provisional application No. 60/913,902, filed on Apr. 25, 2007.

(51) Int. Cl. C08J 9/228; C08K 3/32; C08F 12/08

(52) U.S. Cl. 521/60; 524/417; 521/146

(57) ABSTRACT

Expandable monovinylidene aromatic polymer, e.g., polystyrene, beads are prepared by a suspension polymerization process comprising polymerizing monovinylidene aromatic monomer, e.g., styrene, under suspension polymerization conditions with, based on the weight of the monomer:
A. 0.05 to 0.60 percent by weight (wt %) of tricalcium phosphate,
B. Greater than 0 to 0.1 wt % of calcium carbonate,
C. 0.0002 to 0.005 wt % of co-stabilizer,
D. 0.0001 to 0.01 wt % of a low molecular weight polyethylene wax,
E. 0.4 to 0.9 wt % of a flame retardant, and
F. 2 to 10 wt % of a C₃₋₆ hydrocarbon blowing agent.
   The expandable beads are converted to foam having a low thermal conductivity by contacting the separated and dried expandable beads at foaming conditions with, based on the weight of the monomer:
A. 0.05 to 0.65 wt % of a glyceride comprising units of fatty acids with a C₈₋₂₆ chain length, and
B. 0.005 to 0.30 wt % of a metal stearate.

### CROSS-REFERENCE TO RELATED APPLICATION

This application claims the benefit under 35 USC §119(e) of U.S. Provisional Application No. 60/913,902 filed Apr. 25, 2007.

### FIELD OF THE INVENTION

This invention relates to polystyrene. In one aspect, the invention relates to polystyrene beads while in another aspect, the invention relates to expandable polystyrene beads. In yet another aspect, the invention relates to using the expandable polystyrene beads to make polystyrene foam having a low thermal conductivity and in still another aspect, the invention relates to using the polystyrene foam in the manufacture of construction and building insulation.

### BACKGROUND OF THE INVENTION

Low thermal conductivity is an indispensable property for the use of polystyrene particle foams in building and construction applications such as insulation for walls, roofs, floors and ceiling insulation. However, in the production of insulation boards comprising polystyrene particle foams, the manufacturer desires to reduce the thickness of the boards while at the same maintaining the insulation properties of the boards so as to save on the amount of expandable polystyrene necessary for the application and, consequently, to save on costs. As a result, the manufacturer needs either polystyrene foam with a lower thermal conductivity than that of polystyrene foam of the same density, or polystyrene foam of the same thermal conductivity but with a lower foam density.

### SUMMARY OF THE INVENTION

In one embodiment, expandable polystyrene beads are prepared by a suspension polymerization process comprising polymerizing styrene monomer under suspension polymerization conditions with, based on the weight of the styrene monomer:
A. 0.05 to 0.60 percent by weight (wt %) of tricalcium phosphate,
B. Greater than 0 to 0.1 wt % of calcium carbonate,
C. 0.0002 to 0.005 wt % of a co-stabilizer,
D. 0.0001 to 0.01 wt % of a low molecular weight polyethylene wax with a melting temperature between 100° C. and 120° C., determined by DSC as the maximum of the first scan at a heating rate of 20° K/min,
E. 0.4 to 0.9 wt % of a flame retardant, and
F. 2 to 10 wt % of a C₃₋₆ hydrocarbon blowing agent
   The expandable polystyrene beads are converted to polystyrene foam having a low thermal conductivity by contacting the separated and dried expandable polystyrene beads at foaming conditions with, based on the weight of the styrene monomer:
A. 0.05 to 0.65 wt % of a glyceride comprising units of fatty acids with a C₈₋₂₆ chain length, and
B. 0.005 to 0.30 wt % of a metal stearate.
   The resulting foam has particular application in the manufacture of insulation boards for walls, roofs, ceilings and floors.

### BRIEF DESCRIPTION OF THE DRAWING

The FIGURE is a graph reporting the dependence of thermal conductivity on polystyrene foam density.

### DESCRIPTION OF THE PREFERRED EMBODIMENT

The numerical ranges in this disclosure include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, molecular weight, the number of carbon atoms in a fatty acid chain of a glyceride, and the amount of various components in the reaction mass of a styrene suspension polymerization medium.

“Polymer” means a polymeric compound prepared by polymerizing monomers, whether of the same or a different type. The generic term polymer thus embraces the term homopolymer, usually employed to refer to polymers prepared from only one type of monomer, and the term interpolymer as defined below.

“Copolymer” means a polymer prepared by the polymerization of at least two different types of monomers. This generic term includes the traditional definition of copolymers, i.e., polymers prepared from two different types of monomers, and the more expansive definition of copolymers, i.e., polymers prepared from more than two different types of monomers, e.g., terpolymers, tetrapolymers, etc.

“Blend” and like terms mean a composition of two or more materials. Such a blend may or may not be miscible. Such a blend may or may not be phase separated. Such a blend may or may not contain one or more domain configurations, as determined from transmission electron spectroscopy, light scattering, x-ray scattering, and any other method known in the art.

“Low thermal conductivity” and like terms mean that the thermal conductivity of foams made from the expanded polystyrene beads of this invention is lower than the thermal conductivity of foams made from conventional expanded polystyrene beads, all else equal. The thermal conductivity depends on the mean cell diameter as well as on the density of the expanded polystyrene beads. Low thermal conductivity designates the thermal conductivities reached by expanded polystyrene beads with mean cell diameters at a given foam density according to equation 1 with K-values between 1.8 and 4.

D_{c}=K(a+b/ρ)⁻¹ (1)

In which D_{c} is the mean cell diameter in microns (μm), K is a coefficient, a is 0.016925, b is −0.11137, and ρ is the foam density in grams/liter (g/l). The mean cell diameter is the mean diameter value of the area distribution determined by Scanning Electron Microscopy (SEM) of cut EPS block foam samples (test specimens). The thermal conductivity of the polystyrene foams is measured according to EN 12667.

“Suspension polymerization conditions” and like terms mean the operating conditions, e.g., temperature, pressure, reagent concentrations, solvent (if any), physical state (gas, liquid, slurry, etc.) and the like, at which styrene monomer is polymerized into expandable monovinylidene aromatic homopolymers and copolymer beads, e.g., expandable polystyrene beads. Suspension polymerization processes are well known in the art, e.g., U.S. Pat. No. 5,591,778, and these conditions are illustrated in the examples of this disclosure.

“Foaming conditions” and like terms mean the operating conditions, e.g., temperature, pressure, reagent concentrations, solvent (if any), blowing agent, physical state (gas, liquid, slurry, etc.) and the like, at which expandable monovinylidene aromatic homopolymers and copolymer beads are converted into foam. The process of making the expandable polystyrene beads and expanding the beads into foam are more fully described in U.S. Pat. No. 6,271,272, and these conditions are illustrated in the examples of this disclosure.

### Styrene Monomer

As here used, “styrene monomer” includes any monovinylidene aromatic monomer such as those described in U.S. Pat. Nos. 4,666,987, 4,572,819 and 4,585,825. The monovinylidene aromatic monomers suitable for producing the polymers and copolymers used in the practice of this invention are preferably of the following formula:

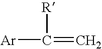

in which R′ is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo-substituted alkyl group. Halo substituents include chloride, bromide and iodo radicals. Preferably, Ar is phenyl or alkylphenyl (in which the alkyl group of the phenyl ring contains 1 to 10, preferably 1 to 8 and more preferably 1 to 4, carbon atoms), with phenyl being most preferred. Typical monovinylidene aromatic monomers which can be used include: styrene, alpha-methylstyrene, all isomers of vinyl toluene, especially para-vinyltoluene, all isomers of ethyl styrene, propyl styrene, vinyl biphenyl, vinyl naphthalene, vinyl anthracene and the like, and mixtures thereof with styrene being the most preferred.

The monovinylidene aromatic monomer can be copolymerized with one or more of a range of other copolymerizable monomers. Preferred comonomers include nitrile monomers such as acrylonitrile, methacrylonitrile and fumaronitrile; (meth)acrylate monomers such as methyl methacrylate or n-butyl acrylate; maleic anhydride and/or N-arylmaleimides such as N-phenylmaleimide, and conjugated and nonconjugated dienes. Representative copolymers include acrylonitrile-butadiene-styrene (ABS) and styrene-acrylonitrile (SAN) copolymers. The copolymers typically contain at least about 1, preferably at least about 2 and more preferably at least about 5, wt % of units derived from the comonomer based on weight of the copolymer. Typically, the maximum amount of units derived from the comonomer is about 40, preferably about 35 and more preferably about 30, wt % based on the weight of the copolymer.

As here used, “polystyrene”, “polystyrene bead” and like terms include any monovinylidene aromatic polymer made from a monovinylidene aromatic monomer. The weight average molecular weight (Mw) of the monovinylidene aromatic polymers used in the practice of this invention can vary widely. For reasons of mechanical strength, among others, typically the Mw is at least about 100,000, preferably at least about 150,000, more preferably at least about 170,000 and most preferably at least about 180,000 g/mol. For reasons of processability, among others, typically the Mw is less than or equal to about 400,000, preferably less than or equal to about 350,000, more preferably less than or equal to about 300,000 and most preferably less than or equal to about 270,000 g/mol.

Similar to the Mw, the number average molecular weight (Mn) of the monovinylidene aromatic polymers used in the practice of this invention can also vary widely. Again for reasons of mechanical strength, among others, typically the Mn is at least about 30,000, preferably at least about 45,000, more preferably at least about 60,000 and most preferably at least about 70,000 g/mol. Also for reasons of processability, among others, typically the Mn is less than or equal to about 130,000, preferably less than or equal to about 120,000, more preferably less than or equal to about 110,000 and most preferably less than or equal to about 105,000 g/mol.

Along with the Mw and Mn values, the ratio of Mw/Mn, also known as polydispersity or molecular weight distribution (MWD), can vary widely. Typically, this ratio is at least about 2, and preferably greater than or equal to about 2.3. The ratio typically is less than or equal to about 4, and preferably less than or equal to about 3. The Mw and Mn are typically determined by gel permeation chromatography using a polystyrene standard for calibration.

The tricalcium phosphate used in the practice of this invention is commercial grade or better, and it is typically present in an amount of at least 0.05, preferably of at least 0.07 and more preferably of at least 0.1, wt % based on the weight of the styrene monomer. The maximum amount of tricalcium phosphate used in the practice of this invention typically does not exceed 0.6, preferably it does not exceed 0.55 and more preferably it does not exceed 0.5, wt % based on the weight of the styrene monomer.

The calcium carbonate used in the practice of this invention is commercial grade or better, and it is typically present in an amount of greater than zero, preferably of at least 0.0005 and more preferably of at least 0.0008, wt % based on the weight of the styrene monomer. The maximum amount of calcium carbonate used in the practice of this invention typically does not exceed 0.1, preferably it does not exceed 0.01 and more preferably it does not exceed 0.005, wt % based on the weight of the styrene monomer.

The co-stabilizer used in the practice of this invention can be added neat or formed in situ. Suitable co-stabilizers are unsaturated mono-, di- and tricarboxylic acids such as acrylic, methacrylic, crotonic, sorbic, maleic, fumaric, citraconic, mesaconic, itaconic, and aconitic acid, and hydrogen sulfites, e.g., sodium hydrogen sulphite. The co-stabilizer used in the practice of this invention is commercial grade or better, and it is typically present in an amount of at least 0.0002, preferably of at least 0.0004 and more preferably of at least 0.0006, wt % based on the weight of the styrene monomer. The maximum amount of co-stabilizer used in the practice of this invention typically does not exceed 0.005, preferably it does not exceed 0.0045 and more preferably it does not exceed 0.004, wt % based on the weight of the styrene monomer.

The combination of tricalcium phosphate, calcium carbonate and co-stabilizer constitute a suspension stabilizer, and it can be compounded prior to or in situ with the styrene monomer. If compounded prior to mixing with the styrene monomer, any mixing equipment can be used and the resulting blend can be added to the styrene monomer under suspension polymerization conditions in any manner using conventional equipment.

The polyethylene wax used in the practice of this invention is a low molecular weight wax, i.e., the average molecular weight does not exceed 10,000, preferably if does not exceed 8,000 and more preferably it does not exceed 5,000, grams/mole (g/mol). The polyethylene wax has a melting temperature between 100 and 120° C. as determined by differential scanning calorimetry as the maximum of the first scan at a heating rate of 20 K/min.

Any flame retardant compatible with the polystyrene beads and foam can be used in the practice of this invention. Preferred flame retardants include the halogenated organic compounds. These compounds include halogenated hydrocarbons such as chlorinated paraffin, e.g., Dechlorane Plus®, an aliphatic, chlorine-containing flame retardant available from the Occidental Chemical Corporation, or hexabromocyclododecane, and halogenated aromatic compounds such as pentabromotoluene, decabromodiphenyl oxide, decabromodiphenyl ethane, and ethylene-bis(tetrabromophthalimide). The flame retardants can be used alone or in combination with one another. One skilled in the art will recognize and select the appropriate flame retardant consistent with the desired performance of the composition.

The flame retardant used in the practice of this invention is typically present in an amount of greater than zero, preferably of at least 0.4 and more preferably of at least 0.5, wt % based on the weight of the styrene monomer. The maximum amount of flame retardant used in the practice of this invention typically does not exceed 0.9, preferably it does not exceed 0.85 and more preferably it does not exceed 0.8, wt % based on the weight of the styrene monomer.

The blowing agent used in the practice of this invention is a C₃₋₆ hydrocarbon. These compounds include butane, pentane, cyclopentane, hexane and mixtures of two or more of these compounds. The blowing agent is present in an amount of at least 2, preferably of at least 3 and more preferably of at least 4, wt % based on the weight of the styrene monomer. The maximum amount of the blowing agent used in the practice of this invention typically does not exceed 10, preferably it does not exceed 8 and more preferably it does not exceed 6, wt % based on the weight of the styrene monomer.

The polystyrene beads of this invention can further comprise one or more fillers and/or additives. These materials are added in known amounts using conventional equipment and techniques. Representative fillers include talc, calcium carbonate, organo-clay, glass fibers, marble dust, cement dust, feldspar, silica or glass, fumed silica, silicates, alumina, carbon black, various phosphorus compounds, ammonium bromide, antimony trioxide, antimony trioxide, zinc oxide, zinc borate, barium sulfate, silicones, aluminum silicate, calcium silicate, titanium oxides, glass microspheres, chalk, mica, clays, wollastonite, ammonium octamolybdate, intumescent compounds, graphite, and mixtures of two or more of these materials. The fillers may carry or contain various surface coatings or treatments, such as silanes, fatty acids, and the like.

The composition can also contain additives such as, for example, antioxidants (e.g., hindered phenols such as, for example, IRGANOX™ 1010 a registered trademark of Ciba Specialty Chemicals), phosphites (e.g., IRGAFOS™ 168 a registered trademark of Ciba Specialty Chemicals), UV stabilizers, cling additives, light stabilizers (such as hindered amines), plasticizers (such as dioctylphthalate or epoxidized soy bean oil), thermal stabilizers, mold release agents, tackifiers (such as hydrocarbon tackifiers), waxes (such as polyethylene waxes), processing aids (such as oils, organic acids such as stearic acid, metal salts of organic acids), crosslinking agents (such as peroxides or silanes), colorants or pigments to the extent that they do not interfere with desired loadings and/or physical or mechanical properties of the compositions of the present invention.

Once the expandable polystyrene beads are formed in the suspension polymerization process, they are separated from the reaction mass by any suitable means, dried, screened and subjected to a finishing step in which the beads are contacted with a glyceride and a metal stearate. The glyceride or plurality of glycerides (e.g., a mixture of mono-, di- and/or triglycerides) comprise one or more units derived from a fatty acid with a C₈₋₂₆ chain length, preferably a C₁₀₋₂₄ and more preferably a C₁₂₋₂₂, chain length. Representative glycerides include but are not limited to glycerides of eicosanoic acid, octadecanoic acid, hexadecanoic acid and tetradecanoic acid.

The glycerides used in the practice of this invention are commercial grade or better, and are typically present in an amount of at least 0.05, preferably of at least 0.1 and more preferably of at least 0.15, wt % based on the weight of the styrene monomer. The maximum amount of glycerides used in the practice of this invention typically does not exceed 0.65, preferably it does not exceed 0.6 and more preferably it does not exceed 0.55, wt % based on the weight of the styrene monomer.

The metal stearate used in the practice of this invention is commercial grade or better, and it is typically present in an amount of greater than zero, preferably of at least 0.005 and more preferably of at least 0.01, wt % based on the weight of the styrene monomer. The maximum amount of metal stearate used in the practice of this invention typically does not exceed 0.3, preferably it does not exceed 0.2 and more preferably it does not exceed 0.15, wt % based on the weight of the styrene monomer. Representative metal stearates include but are not limited to calcium stearate, zinc stearate and barium stearate.

The conditions of the finishing step usually include ambient temperatures between 5 and 50° C. and atmospheric pressure or a slightly greater pressure.

The foams of this invention are used in building and construction insulation boards or panels in the same manner as known foams. In addition to these manufactures, the compositions of this invention can be used in the manufacture of such articles as, but not limited to, containers, packaging, components for consumer electronics and appliances, and the like. These foams are used in the same manner as know foams of monovinylidene aromatic polymers.

The following examples illustrate various embodiments of this invention. All parts and percentages are by weight unless otherwise indicated.

### Specific Embodiments

### EXAMPLE 1

Expandable polystyrene beads yielding polystyrene foam having a low thermal conductivity were received by suspension polymerization of styrene. Into a stirred polymerization reactor charged with 364 liters of H₂0, 820 g of tricalcium phosphate, 88 g of calcium carbonate, and 4.36 g of co-stabilizer, 33 g of ammonium bromide, a solution of 1402 g of dibenzoyl peroxide, 660 g of tert-amylperoxy-2-ethylhexyl carbonate, 900 g of dicumyl peroxide, 51 g of divinyl benzene, 20 g of a low (less than 5,000 g/mol) molecular weight polyethylene wax with a melting temperature of 111° C., determined by differential scanning calorimetry (DSC) as the maximum of the first scan at a heating rate of 20 K/min, and 2970 g of a hexabromocyclododecane in 436 kg of styrene was added. The polymerization was started by increasing the temperature to 88.5° C. and allowed to continue at this temperature for 5 hours. After 4.5 hours, 34.1 kg of pentane were fed. Following, the suspension was heated and the polystyrene beads were allowed to be impregnated with pentane for 3 hours at 115° C. After cooling, the impregnated polystyrene beads were separated from the liquid phase by filtration, centrifugation, and drying under air, yielding expandable polystyrene beads with properties of the water content, of the content of pentane, of the concentration of residual styrene monomer determined by gas chromatography (GC) as well as of number average molecular weight (Mn), weight average molecular weight (Mw), and polydispersity of the molecular weight distribution (MWD) investigated by scanning electron calorimetry (SEC) as shown in Table 1. Additional properties characterizing the particle size distribution of the polystyrene beads received by sieve analysis are summarized in Table 2.

### EXAMPLE 2 (COMPARATIVE)

Expandable polystyrene beads yielding polystyrene foam without having a lower thermal conductivity were received by suspension polymerization of styrene. Into a stirred polymerization reactor charged with 404 liters of H₂0, 640 g of tricalcium phosphate, 80 g of calcium carbonate, and 3.96 g of co-stabilizer, 30 g of ammonium bromide, a solution of 1275 g of dibenzoyl peroxide, 600 g of tert-amylperoxy-2-ethylhexyl carbonate, 815 g of dicumyl peroxide, 46 g of divinyl benzene, 445 g of a low (less than 5,000 g/mol) molecular weight polyethylene wax with a melting temperature of 111° C., determined by DSC as the maximum of the first scan at a heating rate of 20 K/min, and 2700 g of a hexabromocyclododecane in 369 kg of styrene was added. The polymerization was started by increasing the temperature to 88.5° C. and allowed to continue at this temperature for 5 hours. Meantime, after 4.5 hours, 31.0 kg of pentane were fed. Following, the suspension was heated up and the polystyrene beads were allowed to be impregnated with pentane for 3 hours at 115° C. After cooling down, the impregnated polystyrene beads were separated from the liquid phase by filtration, centrifugation, and drying under air, yielding expandable polystyrene beads with properties of the water content, of the content of pentane, of the concentration of residual styrene monomer determined by GC as well as Mn, Mw and MWD investigated by SEC as shown in Table 1. Additional properties characterizing the particle size distribution of the polystyrene beads received by sieve analysis are summarized in Table 2.

TABLE 1
Properties of the Expandable Polystyrene Beads of Ex. 1 and 2

| | | | Concentration | | | |
|---|---|---|---|---|---|---|
| | | Content | of residual | | | |
| | Water | of | styrene | | | |
| Exam- | content | pentane | monomer | Mn | Mw | |
| ple | (wt %) | (wt %) | (ppm) | (g/mol) | (g/mol) | MWD |
| Ex. 1 | 0.63 | 6.55 | 845 | 73,050 | 187,000 | 2.56 |
| Ex. 2 | 0.54 | 6.28 | 715 | 77,200 | 194,900 | 2.52 |
| (Comp.) | | | | | | |
| Ex. 7 | 0.52 | 6.31 | 922 | 76,500 | 185,700 | 2.43 |
| Ex. 8 | 0.54 | 5.97 | 856 | 78,800 | 185,100 | 2.35 |
| Ex. 9 | 0.5 | 6.07 | 876 | 76,500 | 183,900 | 2.4 |
| (Comp.) | | | | | | |

TABLE 2
Properties Characterizing the Particle Size Distribution
of the Polystyrene Beads

| | Particle Size of the Polystyrene Beads | | |
|---|---|---|---|
| | 0.7-1.0 mm | 1.0-1.4 mm | 1.4-1.6 mm |
| Example | (wt %) | (wt %) | (wt %) |
| Ex. 1 | 24.1 | 42.7 | 17.3 |
| Ex. 2 | 19.9 | 51.2 | 19.8 |
| (Comp.) | | | |
| Ex. 7 | 51 | 33.3 | 2.2 |
| Ex. 8 | 45.6 | 36 | 3 |
| Ex. 0 | 42.2 | 39.3 | 4.1 |
| (Comp.) | | | |

### EXAMPLE 3

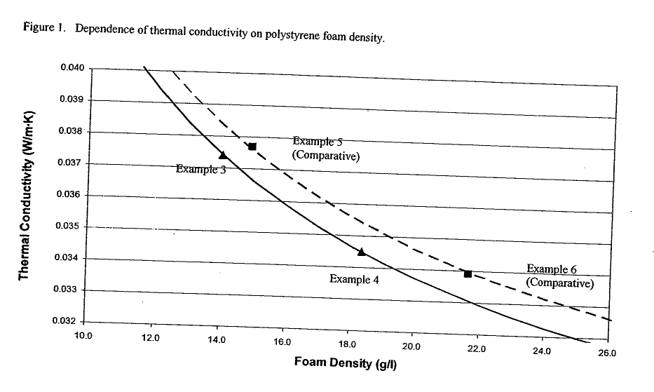

To investigate the thermal conductivity of the polystyrene foam prepared from the expandable polystyrene beads received by the process of the Example 1 and according to test method EN (European Norm) 12667, the beads were sieved to a particle size of 1.0-1.4 mm, coated with 0.24 wt %, based on the weight of the beads, of a mixture of 85 wt % of mono-, di- and tri-glycerides of higher fatty acids with a chain length of C₈₋₂₆ and 15 wt % of zinc stearate. The coated polystyrene beads were pre-foamed by addition of steam at atmospheric pressure, dried for 24 hours at a temperature of 70° C., and converted into a molded bead foam article using a block mold by final foaming with steam. The mold was a conventional perforated block mold. The steam was low pressure steam. After removing the article from the mold, test specimens were cut from the article and stored at a temperature of 70° C. for a period of 72 hours before subjecting the test specimens to the testing of the thermal conductivity. After determining the foam density of the test specimens at 14.0 g/l, a thermal conductivity of 0.0374 W/(m K) determined. This result is shown in FIG. 1 in comparison to the adjusted curve of the average of the thermal conductivity of EN 13163. The mean cell diameter of the foam as the mean diameter value of the area distribution determined by SEM of cut EPS block foam samples (test specimens) is shown in Table 3 together with the coefficient K in Equation 1.

TABLE 3
Mean Cell Diameter of the Test Specimens and
Co-Efficient K in Equation 1

| Example | Mean Cell Diameter (μm) | Co-Efficient K |
|---|---|---|
| Ex. 3 | 240 | 2.16 |
| Ex. 4 | 200 | 2.17 |
| Ex. 5 (Comp.) | 105.8 | 1 |
| Ex. 6 (Comp.) | 84.8 | 1 |
| Ex. 10 | 195.5 | 2.18 |
| Ex. 11 | 157.5 | 1.92 |
| Ex. 12 | 162.5 | 1.86 |
| Ex. 13 | 150.7 | 1.85 |
| Ex. 14 | 166.6 | 1.94 |

### EXAMPLE 4

According to Example 3, polystyrene beads were prepared from the expandable polystyrene beads received by the process of the Example 1 by separation and coating with 0.24 wt %, based on the weight of the beads, of a mixture of 85 wt % of mono-, di- and tri-glycerides of higher fatty acids with a chain length of C₈₋₂₆ and 15 wt % of zinc stearate. The coated polystyrene beads were pre-foamed and converted into a molded bead foam article according to Example 3 and also tested for thermal conductivity according to EN 12667. After determining the foam density of the test specimens at 18.4 g/l, a thermal conductivity of 0.0345 W/(m·K) was determined. This result is shown in FIG. 1 in comparison to the adjusted curve of the average of the thermal conductivity of EN 13163.

### EXAMPLE 5 (COMPARATIVE)

To investigate the thermal conductivity of the polystyrene foam prepared of the expandable polystyrene beads received by the process of the comparative Example 2 and according to the test method EN 12667, the beads were sieved to a particle size of 1.0-1.4 mm, coated with 0.24 wt %, based on the weight of the beads, of a mixture of 85 wt % of a mono-, di- and tri-glycerides of higher fatty acids with a chain length of C₈₋₂₆ and 15 wt % of zinc stearate. The coated polystyrene beads were pre-foamed by addition of steam at atmospheric pressure, dried for 24 hours at a temperature of 70° C., and converted into a molded bead foam article using a block mold by final foaming with steam. The mold is a conventional perforated block mold. The steam is low pressure steam. After removing the article from the mold, test specimens were cut from the article and stored at a temperature of 70° C. for a period of 72 hours before subjecting the test specimens to the testing of the thermal conductivity. After determining the foam density of the test specimens at 14.9 g/l, a thermal conductivity of 0.0377 W/(m·K) was determined. This result is shown in FIG. 1 in comparison to the adjusted curve of the average of the thermal conductivity of EN 13163.

### EXAMPLE 6 (COMPARATIVE)

According to Comparative Example 5, polystyrene beads were prepared of the expandable polystyrene beads received from the process of the Example 2 by separation and coating with 0.24 wt %, based on the weight of the beads, of a mixture of 85 wt % of a by mono-, di- and tri-glycerides of higher fatty acids with a chain length of C₈₋₂₆ and 15 wt % of zinc stearate. The coated polystyrene beads were pre-foamed and converted into a molded bead foam article according to Example 5 and also tested for thermal conductivity according to EN 12667. After determining the foam density of the test specimens at 21.7 g/l, a thermal conductivity of 0.0339 W/(m·K) was determined. This result is shown in FIG. 1 in comparison to the adjusted curve of the average of the thermal conductivity of EN 13163.

As a result of the samples reported in FIG. 1, a lower thermal conductivity of the polystyrene foam at the same density, or the same thermal conductivity of the polystyrene foam at a lower foam density, are achieved by Examples 1, 3 and 4 in comparison to the Comparative Examples 2, 5 and 6. This shows the preparation of expandable polystyrene beads yielding polystyrene foam having the advantageous property of a lower thermal conductivity.

### EXAMPLE 7

Example 1 was repeated except that 10 grams of the low molecular weight polyethylene wax was used instead of 20 grams.

### EXAMPLE 8

Example 1 was repeated except that 24.4 grams of the low molecular weight polyethylene wax was used instead of 20 grams.

### EXAMPLE 9 (COMPARATIVE)

Example 1 was repeated except that the low molecular weight polyethylene wax was omitted.

### EXAMPLE 10

Example 3 was repeated except that after determining the foam density of the test specimens at 19.3 g/l, a thermal conductivity of 0.0342 W/m K (shown in the FIGURE) was determined.

### EXAMPLE 11

Example 3 was repeated except that after determining the foam density of the test specimens at 23.6 g/l, a thermal conductivity of 0.0342 W/m K (shown in the FIGURE) was determined.

### EXAMPLE 12

Example 3 was repeated using, however, the expandable polystyrene beads produced by the process of Example 7. After determining the foam density of the test specimens at 20.3 g/l, a thermal conductivity of 0.0335 W/m K (shown in the FIGURE) was determined.

### EXAMPLE 13

Example 3 was repeated using, however, the expandable polystyrene beads produced by the process of Example 7. After determining the foam density of the test specimens at 23.8 g/l, a thermal conductivity of 0.0325 W/m K (shown in the FIGURE) was determined.

### EXAMPLE 14

Example 3 was repeated using, however, the expandable polystyrene beads produced by the process of Example 8. After determining the foam density of the test specimens at 21.1 g/l, a thermal conductivity of 0.0332 W/m K (shown in the FIGURE) was determined.

### EXAMPLE 15 (COMPARATIVE)

Example 3 was repeated using, however, the expandable polystyrene beads produced by the process of Example 9. After the preparation of the test specimens, an EPS particle foam with an undesired structure showing holes with diameters of 1000 μm and larger was determined.

Although the invention has been described in considerable detail in the preceding examples, this detail is for the purpose of illustration and is not to be construed as a limitation on the scope of the invention as described in the pending claims. All U.S. patents and published patent applications identified above are incorporated herein by reference.

What is claimed is:

1. A process for preparing expandable monovinylidene aromatic polymer beads, the process comprising polymerizing a monovinylidene aromatic monomer under suspension polymerization conditions with, based on the weight of the monovinylidene aromatic monomer:
A. 0.05 to 0.60 percent by weight (wt %) of tricalcium phosphate,
B. Greater than 0 to 0.1 wt % of calcium carbonate,
C. 0.0002 to 0.005 wt % of a co-stabilizer,
D. 0.0001 to 0.01 wt % of a low molecular weight polyethylene wax with a melting temperature between 100° C. and 120° C., determined by DSC as the maximum of the first scan at a heating rate of 20° K/min,
E. 0.4 to 0.9 wt % of a flame retardant, and
F. 2 to 10 wt % of a C₃₋₆ hydrocarbon blowing agent.

2. The process of claim 1 in which the monovinylidene aromatic monomer is of the formula: 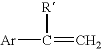
in which R′ is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo-substituted alkyl group.

3. The process of claim 2 in which the monovinylidene aromatic monomer is styrene.

4. The process of claim 3 in which the molecular weight of the polyethylene wax does not exceed 10,000 g/mol.

5. The process of claim 4 in which the flame retardant is a halogenated organic compound.

6. The process of claim 5 in which the blowing agent is at least one of butane, pentane, cyclopentane and hexane.

7. Expandable monovinylidene aromatic polymer beads prepared by the process of claim 1.

8. Expandable polystyrene beads prepared by the process of claim 6.

9. The beads of claim 8 further comprising at least one of an antioxidant, filler, UV stabilizer, cling additive, light stabilizer, thermal stabilizer, mold release agent, tackifier, processing aid, crosslinking agent, colorant and pigment.

10. A process for preparing monovinylidene aromatic polymer foam having a low thermal conductivity, the process comprising foaming the expandable monovinylidene aromatic polymer beads of claim 1 under foaming conditions with, based on the weight of the monovinylidene aromatic monomer:
A. 0.05 to 0.65 wt % of a glyceride comprising units of fatty acids with a C₈₋₂₆ chain length, and
B. 0.005 to 0.30 wt % of a metal stearate.

11. The process of claim 10 comprising the further steps of drying and screening the beads of claim 1 before subjecting the beads to the foaming conditions.

12. The process of claim 11 in which the expandable monovinylidene aromatic polymer beads are polystyrene beads.

13. The process of claim 12 in which the glyceride is at least one glyceride of eicosanoic acid, octadecanoic acid, hexadecanoic acid and tetradecanoic acid.

14. The process of claim 13 in which the metal stearate is at least one of calcium stearate, zinc stearate and barium stearate.

15. Monovinylidene aromatic polymer foam made by the process of claim 10.

16. Polystyrene foam made by the process of claim 14.

17. Construction or building insulation board comprising the monovinylidene aromatic polymer foam of claim 15.

18. Construction or building insulation board comprising the polystyrene foam of claim 17.
